(19) United States
(12) Patent Application Publication
(10) Pub. No.: US 2022/0036844 A1
(43) Pub. Date: Feb. 3, 2022

(54) METHOD FOR DETERMINING OVERDRIVE VOLTAGE, DISPLAY PANEL AND COMPUTER READABLE STORAGE MEDIUM

(71) Applicants: CHONGQING HKC OPTOELECTRONICS TECHNOLOGY CO., LTD., Chongqing (CN); HKC CORPORATION LIMITED, Shenzhen (CN)

(72) Inventors: Wei CHEN, Chongqing (CN); Wei LI, Chongqing (CN)

(21) Appl. No.: 17/160,678

(22) Filed: Jan. 28, 2021

(30) Foreign Application Priority Data
Jul. 28, 2020 (CN) 202010741425.3

(51) Int. Cl. G09G 3/36; G09G 3/3258

(52) U.S. Cl. CPC G09G 3/3655; G09G 3/3688; G09G 2310/0251; G09G 3/3258; G09G 2310/06; G09G 3/3618

(57) ABSTRACT

The application discloses a method for determining overdrive voltage, which includes the following operations: determining a gray scale value of a pixel to be displayed of a current display picture and a picture type of the current display picture; determining a target refresh rate according to the picture type; and determining a target overdrive voltage of the pixel to be displayed according to the target refresh rate and the gray scale value of the pixel to be displayed, where the target refresh rate and the target overdrive voltage are positively correlated. The application also discloses a display panel and a computer readable storage medium. The display panel of the present application reasonably determines the overdrive voltage.

### CROSS-REFERENCE TO RELATED APPLICATIONS

The present disclosure claims the priority to a Chinese patent application no. 202010741425.3, filed on Jul. 28, 2020, entitled “Method for Determining Overdrive Voltage, Display Panel and Computer Readable Storage Medium”, the entire content of which is incorporated herein for reference.

### TECHNICAL FIELD

The application relates to the technical field of display equipments, in particular to a method for determining overdrive voltage, a display panel and a computer readable storage medium.

### BACKGROUND

The statements herein only provide background information related to this disclosure and does not necessarily constitute prior art.

In the technical field of display equipments, refresh rate refers to the number of times an electron beam repeatedly scans an image on a screen. The higher the refresh rate, the more stability of the picture displayed by the display device.

When the refresh rate is high, the corresponding response time of liquid crystal molecules is small, so the overdrive voltage applied to liquid crystal molecules is larger. However, the greater the overdrive voltage, the greater the energy consumed by the display panel. However, when the refresh rate is low, the corresponding response time of liquid crystal molecules is large, that is, the overdrive voltage of liquid crystal molecules is small, which reduces the energy consumption of display equipments, but causes a dragging problem. Therefore, the determination of overdrive voltage of display panel is unreasonable.

### SUMMARY

The main object of the present application is to provide a method for determining overdrive voltage, a display panel and a computer readable storage medium, aiming to solve the problem that the determination of overdrive voltage by the display panel is unreasonable.

In order to achieve the above objective, the present application provides a method for determining overdrive voltage, which includes the following operations:

determining a gray scale value of a pixel to be displayed of a current display picture and a picture type of the current display picture;

determining a target refresh rate according to the picture type; and

determining a target overdrive voltage of the pixel to be displayed according to the target refresh rate and the gray scale value of the pixel to be displayed, the target refresh rate and the target overdrive voltage being positively correlated.

In an embodiment, the operation of determining a target overdrive voltage of the pixel value to be displayed according to the target refresh rate and the gray scale value of the pixel to be displayed includes:

determining an overdrive voltage of the pixel to be displayed according to the gray scale value; and

correcting the overdrive voltage according to the target refresh rate to obtain the target overdrive voltage of the pixel to be displayed.

In one embodiment, the operation of correcting the overdrive voltage according to the target refresh rate to determine a target overdrive voltage for the pixel to be displayed includes:

determining a correction parameter according to the target refresh rate; and

correcting the overdrive voltage according to the correction parameter to obtain the target overdrive voltage of the pixel to be displayed.

In one embodiment, the operation of the operation of correcting the overdrive voltage according to the target refresh rate to determine the target overdrive voltage of the pixel to be displayed comprises:

obtaining a preset refresh rate and comparing the target refresh rate with the preset refresh rate;

in responding to that the target refresh rate is greater than the preset refresh rate, increasing the overdrive voltage to obtain the target overdrive voltage of the pixel to be displayed;

in responding to that the target refresh rate is less than the preset refresh rate, decreasing the overdrive voltage to obtain the target overdrive voltage of the pixel to be displayed.

In one embodiment, the operation of determining a target refresh rate according to the picture type comprises:

determining a preset refresh rate;

correcting the preset refresh rate according to the picture type to obtain the target refresh rate.

In one embodiment, picture types comprise a static picture and a dynamic picture, and the operation of correcting the preset refresh rate according to the picture type to obtain a target refresh rate comprises:

in responding to that the current display picture is a static picture according to the picture type, decreasing the preset refresh rate to obtain the target refresh rate; and

in responding to that the current display picture is a dynamic picture according to the picture type, increasing the preset refresh rate to obtain the target refresh rate.

In one embodiment, after the operation of determining a target overdrive voltage of the pixel to be displayed according to the target refresh rate and the gray scale value of the pixel to be displayed, the operation further comprises:

in responding to that display of the current display picture is completed, determining a display time point of a next picture frame to be displayed according to the target refresh rate;

in responding to that the display time point arrives, taking the next picture frame to be displayed as the current display picture and returning to repeat the operation of determining a gray scale value of a pixel to be displayed of a current display picture.

In one embodiment, picture types includes a static picture and a dynamic picture, the operation of determining a picture type of the current display picture comprises:

acquiring a previous display picture frame;

determining a second pixel of the previous display picture frame corresponding to a first pixel of the current display picture, and comparing a pixel value of the first pixel with a pixel value of the second pixel;

determining that the current display picture is a static picture according to the picture type when a number of first pixels whose pixel values are same as pixel values of corresponding second pixels is greater than a first preset number; and

determining that the current display picture is a dynamic picture when a number of first pixels whose pixel values are different from pixel values of corresponding second pixels is greater than a second preset number.

To achieve the above objective, the present application also provides a display panel including a memory and at least one processor. The memory stores computer-executable instructions executable by at least one processor, when the computer-executable instructions are executed by the at least one processor, the computer-executable instructions cause the at least one processor to perform operations of the above mentioned method for determining overdrive voltage.

To achieve the above objective, the application also provides a computer readable storage medium storing computer executable instructions executable by at least one processor, when the computer executable instructions are executed by the at least one processor, the computer executable instructions cause the at least one processor to perform operations of the above mentioned method for determining overdrive voltage.

According to the method for determining overdrive voltage, a display panel and a computer readable storage medium, the display panel determines gray scale value of a pixel to be displayed of a current display picture and a picture type of the current display picture, and then determines a target refresh rate according to the picture type, so as to determine a target overdrive voltage of the pixel to be displayed according to the target refresh rate and the gray scale value. Since the display panel can adjust the refresh rate according to the picture type of the current display picture, the target overdrive voltage of the pixel to be displayed of the current display picture is determined according to the adjusted refresh rate, that is, the overdrive voltage of the pixel to be displayed is adjusted according to the refresh rate determined according to the picture type of the current display picture, and the display panel reasonably determines the overdrive voltage.

### BRIEF DESCRIPTION OF THE DRAWINGS

FIG. 1 is a schematic diagram of a hardware structure of a display panel according to an embodiment of the present application;

FIG. 2 is a flow diagram of an embodiment of a method for determining over-drive voltage of the present application;

FIG. 3 is a detailed flow diagram of determining a picture type of the current display picture of operation S100 of FIG. 2;

FIG. 4 is a detailed flow diagram of operation S300 of FIG. 2;

FIG. 5 is a detailed flow diagram of operation S320 of FIG. 4;

FIG. 6 is another detailed flow diagram of operation S320 of FIG. 4;

FIG. 7 is a detailed flow diagram of operation S200 of FIG. 2.

The realization of purposes, functional features and advantages of the present disclosure will be further explained in connection with embodiments and with reference to the accompanying drawings.

### DETAILED DESCRIPTION OF THE EMBODIMENTS

It should be understood that the specific embodiments described herein are intended to explain the application only and are not intended to limit the application.

A solution of an embodiment of the application is to determine a gray scale value of a pixel to be displayed of a current display picture and a picture type of the current display picture; determine a target refresh rate according to the picture type; and determine a target overdrive voltage of the pixel to be displayed according to the target refresh rate and the gray scale value of the pixel to be displayed, the target refresh rate and the target overdrive voltage being positively correlated.

As the display panel can adjust the refresh rate according to the picture type of the current display picture, the target overdrive voltage of the pixel to be displayed in the current display picture is determined according to the adjusted refresh rate, that is, the overdrive voltage of the pixel to be displayed is adjusted according to the refresh rate determined according to the picture type of the current display picture. The display panel reasonably determines the overdrive voltage.

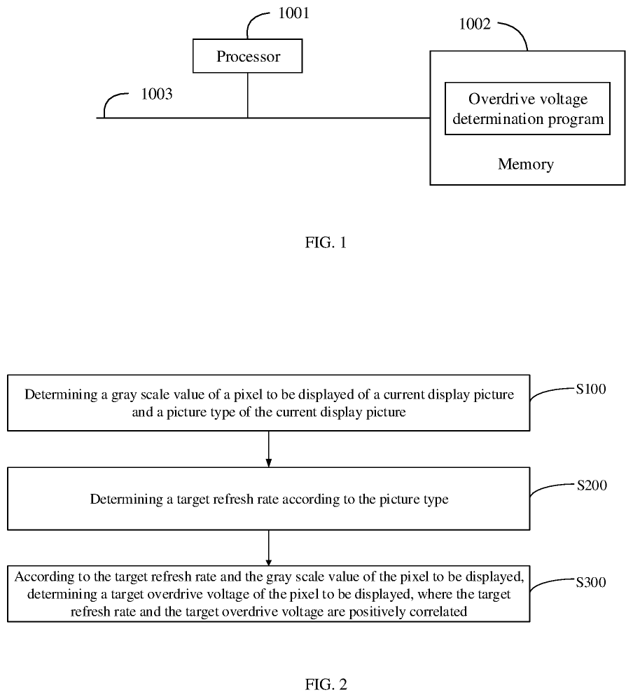

As one implementation, the display panel can be shown as that in FIG. 1.

The embodiment of the present application relates to a display panel, which includes a processor 1001 such as a CPU, a memory 1002, and a communication bus 1003. The communication bus 1003 is configured to enable connection and communication between those components.

The memory 1002 may be a high-speed RAM memory (Random Access Memory) or a stable memory (non-volatile memory), such as a magnetic disk memory. As shown in FIG. 1, the memory 1003, as a computer storage medium can include an overdrive voltage determination program. The processor 1001 can be configured to invoke the overdrive voltage determination program stored in the memory 1002 and perform the following operations:

determining a gray scale value of a pixel to be displayed of a current display picture and a picture type of the current display picture;

determining a target refresh rate according to the picture type; and

according to the target refresh rate and the gray scale value of the pixel to be displayed, determining a target overdrive voltage of the pixel to be displayed, the target refresh rate and the target overdrive voltage being positively correlated.

In one embodiment, the processor 1001 can be configured to invoke the overdrive voltage determination program stored in the memory 1002 and perform the following operations:

determining an overdrive voltage of the pixel to be displayed according to the gray scale value;

correcting the overdrive voltage according to the target refresh rate to obtain the target overdrive voltage of the pixel to be displayed.

In one embodiment, the processor 1001 can be configured to invoke the overdrive voltage determination program stored in the memory 1002 and perform the following operations:

determining a correction parameter according to the target refresh rate;

correcting the overdrive voltage according to the correction parameter to obtain the target overdrive voltage of the pixel to be displayed.

In one embodiment, the operation of correcting the overdrive voltage according to the target refresh rate to obtain the target overdrive voltage of the pixel to be displayed includes:

obtaining a preset refresh rate and comparing the target refresh rate with the preset refresh rate;

in responding to that the target refresh rate is greater than the preset refresh rate, increasing the overdrive voltage to obtain the target overdrive voltage of the pixel to be displayed;

in responding to that the target refresh rate is less than the preset refresh rate, decreasing the overdrive voltage to obtain the target overdrive voltage of the pixel to be displayed.

In one embodiment, the processor 1001 can be configured to invoke the overdrive voltage determination program stored in the memory 1002 and perform the following operations:

determining the preset refresh rate;

correcting the preset refresh rate according to the picture type to obtain the target refresh rate.

In one embodiment, the processor 1001 can be configured to invoke the overdrive voltage determination program stored in the memory 1002 and perform the following operations:

in responding to that the current display picture is a static picture according to the picture type, decreasing the preset refresh rate to obtain the target refresh rate;

in responding to that the current display picture is a dynamic picture according to the picture type, increasing the preset refresh rate to obtain the target refresh rate.

In one embodiment, the processor 1001 can be configured to invoke the overdrive voltage determination program stored in the memory 1002 and perform the following operations:

in responding to that the display of the current display picture is completed, determining a display time point of a next picture frame to be displayed according to the target refresh rate;

in responding to that the display time point arrives, taking the next picture frame to be displayed as the current display picture and returning to repeat the operation of determining a gray scale value of a pixel to be displayed of a current display picture.

In one embodiment, the processor 1001 can be configured to invoke the overdrive voltage determination program stored in the memory 1002 and perform the following operations:

acquiring a previous display picture frame;

determining a second pixel of the previous display picture frame corresponding to a first pixel of the current display picture, and comparing a pixel value of the first pixel with a pixel value of the second pixel;

determining that the current display picture is a static picture according to the picture type when a number of first pixels whose pixel values are same as pixel values of corresponding second pixels is greater than a first preset number; and

determining that the current display picture is a dynamic picture when a number of first pixels whose pixel values are different from pixel values of corresponding second pixels is greater than a second preset number.

According to the above scheme of the present application, the display panel determines a gray scale value of a pixel to be displayed of a current display picture and a picture type of the current display picture, and then determines a target refresh rate according to the picture type, so as to determine a target overdrive voltage of the pixel to be displayed according to the target refresh rate and the gray scale value. Since the display panel can adjust the refresh rate according to the picture type of the current display picture, the target overdrive voltage of the pixel to be displayed in the current display picture is determined according to the adjusted refresh rate, that is, the overdrive voltage of the pixel to be displayed is adjusted according to the refresh rate determined by the picture type of the current display picture, and the display panel reasonably determines the overdrive voltage.

Based on the above hardware architecture, an embodiment of a method for determining an overdrive voltage of the present application is provided.

Referring to FIG. 2, FIG. 2 is an embodiment of a method for determining overdrive voltage according to the present application, the method includes the following operations:

operation S100, determining a gray scale value of a pixel to be displayed of a current display picture and a picture type of the current display picture;

In the present embodiment, the execution body of the method is a display panel. After receiving an image signal, the display panel analyzes the image signal to obtain the current display picture, and the current display picture is a picture to be displayed. The current display picture includes a plurality of pixels. Each pixel has a corresponding pixel value. Since there are many pixels in the current display picture, the pixel value of each pixel obtained by analyzing the image signal is compressed data. The display panel needs to further decompress the analyzed data to obtain the pixel value corresponding to each pixel, and then convert the pixel value into a gray scale value.

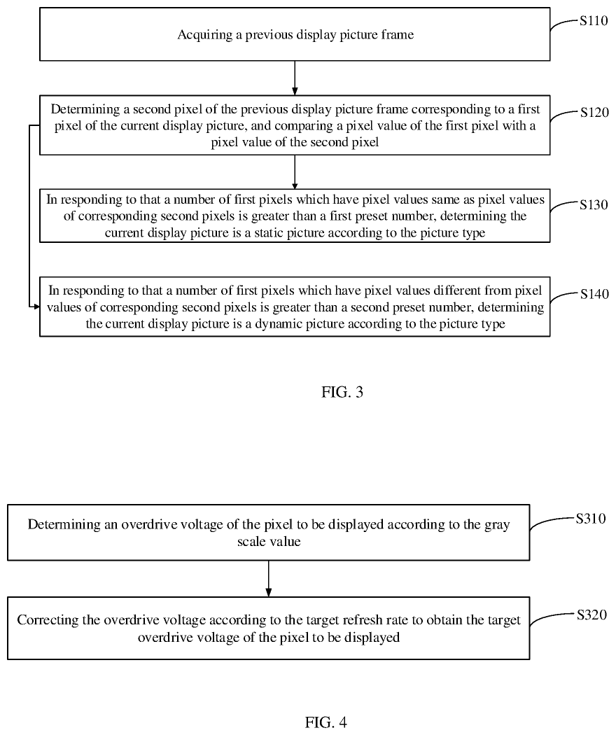

Display pictures are divided into a variety of picture types, which include dynamic pictures and static pictures. The display panel is provided with a DDR (Double Data Rate Synchronous Dynamic Random Access memory) for storing gray scale values of pixels of a previous display picture frame. The display panel can determine a picture type of the current display picture by comparing the current display picture with the previous display picture frame. Specifically, please refer to FIG. 3, the operation of determining a picture type of the current display picture in operation S100 includes:

Operation S110, acquiring a previous display picture frame;

Operation S120, determining a second pixel of the previous display picture frame corresponding to a first pixel of the current display picture, and comparing a pixel value of the first pixel with a pixel value of the second pixel;

Operation S130, in responding to that a number of first pixels which have pixel values same as pixel values of corresponding second pixels is greater than a first preset number, determining the current display picture is a static picture according to the picture type;

operation S140, in responding to that a number of first pixels which have pixel values different from pixel values of corresponding second pixels is greater than a second preset number, determining the current display picture is a dynamic picture according to the picture type.

The display panel obtains a pixel value of each pixel of the previous display picture frame from the DDR, and defines each pixel of the previous display picture frame as a second pixel, and each pixel of the current display picture as a first pixel. The display panel further determines the second pixels corresponding to the first pixels one by one. Each first pixel and the second pixel corresponding to the first pixel have a same display position on the display panel. The display panel further compares the pixel values of the first pixels with the pixel values of the second pixels, and if the pixel value of each first pixel is the same as the pixel value of the second pixel corresponding to the first pixel, it indicates that the current display picture and the previous display picture frame are the same, and the current display picture is determined to be a static picture according to the picture type. If the current display picture contains one or more first pixel(s) whose pixel value(s) is(are) different from the pixel value(s) of the second pixel(s) corresponding to the first pixel(s), it indicates that the current display picture changes as compared to the previous display picture frame, and the current display picture is a dynamic picture according to the picture type.

In addition, the display panel can also determine the number of first pixels whose pixel values are same as pixel values of the second pixels corresponding to the first pixels. If the number is greater than a first preset number, it can be determined that the current display picture only changes in a small range as compared with the previous display picture frame, i.e., the current display picture is also defined as a static picture according to the picture type. The first preset number can be determined according to a total number of pixels and a proportion threshold. If the number is less than or equal to the first preset number, it can be determined that the current display picture has changed in a large range as compared with the previous display picture frame, i.e., the current display picture is defined as a dynamic picture according to the picture type.

Of course, the display panel can also determine a number of first pixels whose pixel values are different from the pixel values of the second pixels corresponding to the first pixels. If the number is greater than a second preset number, it can be determined that the current display picture has changed in a large range as compared with the previous display picture frame, i.e., the current display picture is defined as a dynamic picture according to the picture type. The second preset number can be determined according to the total number of pixels and a proportion threshold. If the number is less than or equal to the second preset number, it can be determined that the current display picture has changed in a small range as compared with the previous display picture frame, i.e., the current display picture is also defined as a static picture according to the picture type.

Operation S200, determining a target refresh rate according to the picture type.

The display panel can store a mapping relationship between picture types and refresh rates. The picture types include but are not limited to a dynamic picture and a static picture. The display panel can determine a refresh rate according to the mapping relationship and the picture type, and the refresh rate is the target refresh rate.

The display panel playing pictures according to a corresponding frame rate, for example, the frame rate being 200 indicates that the display panel can play 200 frames of pictures theoretically in one second. The refresh rate refers to the number of times electron beams repeatedly scan pictures on a screen. The refresh rate is the number of pictures actually played by the display panel in one second. The refresh rate is generally 60 Hz, i.e. the display panel actually plays 60 pictures in one second. It can be understood that, in general, the display panel selects 60 of the 200 pictures for display. In this embodiment, the refresh rate of a dynamic picture is higher than that of a static picture, the reason is that, the characters and scenes in the dynamic picture have changed greatly, if the refresh rate is low, for example, the refresh rate is 50 Hz, it indicates that four picture frames are not displayed on the display panel between a previous picture frame displayed immediately before a currently displayed picture frame and the currently displayed picture frame, thus causing incoherent movements of people displayed on the display panel and even dragging phenomenon. Therefore, it is necessary to improve the refresh rate. However, when the current display picture is a static picture, the change of characters or scenes is small or even unchanged, so the refresh rate is small and there will be no dynamic incoherence or dragging of characters. At this time, the refresh rate can be appropriately reduced.

Operation S300, according to the target refresh rate and the gray scale value of the pixel to be displayed, determining a target overdrive voltage of the pixel to be displayed, where the target refresh rate and the target overdrive voltage are positively correlated.

When the display panel displays a pixel, it is needed to apply a voltage to liquid crystal molecules corresponding to the pixel. However, it takes a certain time for the liquid crystal molecules to start rotating. a time between the application of voltage to the liquid crystal molecules and the start of rotation of the liquid crystal molecules is a response time of liquid crystal, which determines the refresh rate of the display panel. In order to shorten the response time of liquid crystal, it is necessary to apply a voltage greater than a set voltage of the liquid crystal molecules to the liquid crystal molecules. The set voltage is determined according to the gray scale value corresponding to the pixels, and the voltage greater than the set voltage is the overdrive voltage. It can be understood that the larger the target refresh rate, the shorter the response time of liquid crystal, and the larger the target overdrive voltage corresponding to the pixel. The target refresh rate has a positive correlation with the target overdrive voltage. When the overdrive voltage of the pixel is 4V, relationships between target refresh rates and target overdrive voltages are shown in Table 1:

TABLE 1

| Target | Overdrive | Target | Overdrive | Target | Overdrive |
|---|---|---|---|---|---|
| Refresh | Voltage | Refresh | Voltage | Refresh | Voltage |
| Rate (Hz) | (V) | Rate (Hz) | (V) | Rate (Hz) | (V) |
| 45 | 3.70 | 46 | 3.72 | 47 | 3.74 |
| 48 | 3.76 | 49 | 3.78 | 50 | 3.80 |
| 51 | 3.82 | 52 | 3.84 | 53 | 3.86 |
| 54 | 3.88 | 55 | 3.90 | 56 | 3.92 |
| 57 | 3.94 | 58 | 3.96 | 59 | 3.98 |
| 60 | 4.00 | 61 | 4.02 | 62 | 4.04 |
| 63 | 4.06 | 64 | 4.08 | 65 | 4.10 |
| 66 | 4.12 | 67 | 4.14 | 68 | 4.16 |
| 69 | 4.18 | 70 | 4.20 | 71 | 4.22 |
| 72 | 4.24 | 73 | 4.26 | 74 | 4.28 |
| 75 | 4.30 | 76 | 4.32 | | |

The display panel needs to control the response time of liquid crystal of liquid crystal molecules to meet the refresh rate requirement. However, the response time of liquid crystal is determined by the overdrive voltage. Thus, a variety of overdrive voltage look-up tables are stored in the display panel, and the refresh rates corresponding to the look-up tables are different. After determining the target refresh rate, the display panel can determine a corresponding look-up table according to the target refresh rate, and determine the overdrive voltage corresponding to the gray scale value of the pixel to be displayed in the look-up table. The overdrive voltage determined is the target overdrive voltage of the pixel to be displayed.

After determining the target overdrive voltage of the pixel to be displayed, the target overdrive voltage can be applied to the pixel to be displayed to display a picture corresponding to the pixel to be displayed on the display panel.

After the last pixel to be displayed of the current display picture is displayed, the display of a next picture frame to be displayed needs to be performed. Since the refresh rate of the display panel changes in real time, the display panel needs to determine the display time point of the next picture frame to be displayed according to the target refresh rate, and can receive the next picture frame to be displayed when the display time point arrives. At this time, the next picture frame to be displayed is taken as the current display picture, and operations S100-S300 is repeated.

In the technical scheme provided by the present embodiment, the display panel determines a gray scale value of a pixel to be displayed of a current display picture and a picture type of the current display picture, and then determines a target refresh rate according to the picture type, so as to determine a target overdrive voltage of the pixel to be displayed according to the target refresh rate and the gray scale value. Since the display panel can adjust the refresh rate according to the picture type of the current display picture, the target overdrive voltage of the pixel to be displayed of the current display picture is determined according to the adjusted refresh rate, that is, the overdrive voltage of the pixel to be displayed is adjusted according to the refresh rate determined according to the picture type of the current display picture, and the display panel reasonably determines the overdrive voltage.

Referring to FIG. 4, FIG. 4 is a detailed flow diagram of operation S300 of FIG. 2, which includes:

Operation S310, determining an overdrive voltage of the pixel to be displayed according to the gray scale value;

Operation S320, correcting the overdrive voltage according to the target refresh rate to obtain the target overdrive voltage of the pixel to be displayed.

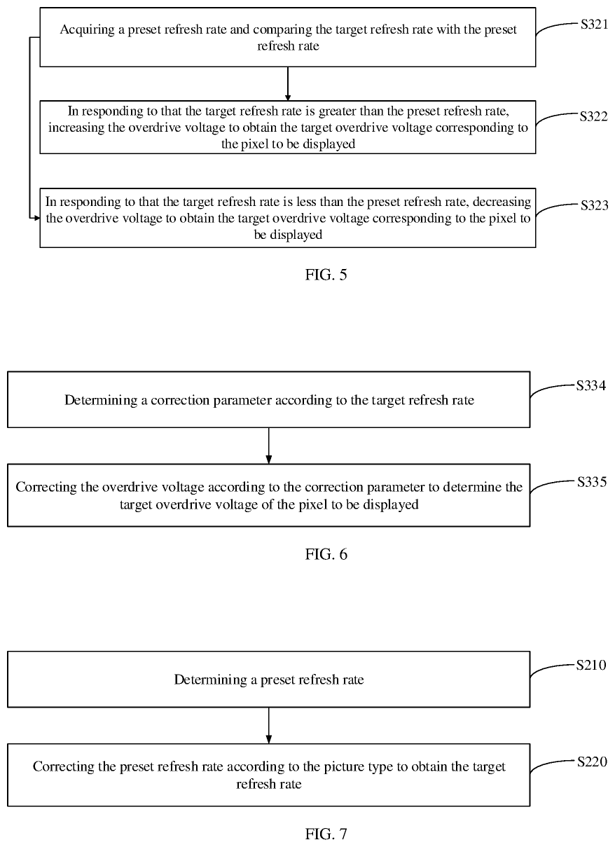

In this embodiment, the display panel stores a look-up table of gray scale values and overdrive voltages, and the display panel can search in the look-up table to obtain the overdrive voltage corresponding to the gray scale value of the pixel to be displayed. The establishment of the look-up table is based on testing the display panel under the preset refresh rate. Therefore, the display panel needs to correct the overdrive voltage according to the target refresh rate and the preset refresh rate to obtain the target overdrive voltage. Specifically, please refer to FIG. 5, operation S320 includes:

Operation S321, acquiring a preset refresh rate and comparing the target refresh rate with the preset refresh rate;

Operation S322, in responding to that the target refresh rate is greater than the preset refresh rate, increasing the overdrive voltage to obtain the target overdrive voltage corresponding to the pixel to be displayed;

Operation S323, in responding to that the target refresh rate is less than the preset refresh rate, decreasing the overdrive voltage to obtain the target overdrive voltage corresponding to the pixel to be displayed.

The display panel compares the target refresh rate with the preset refresh rate. If the target refresh rate is greater than the preset refresh rate, it means that the response time of liquid crystal corresponding to the target refresh rate is shorter than the response time of liquid crystal corresponding to the preset refresh rate, thus the overdrive voltage should be increased to obtain the target overdrive voltage, and an increased amount can be determined according to the difference between the response times of liquid crystal corresponding to the two.

If the target refresh rate is less than the preset refresh rate, it means that the response time of liquid crystal corresponding to the target refresh rate is longer than the response time of liquid crystal corresponding to the preset refresh rate, thus the overdrive voltage should be reduced to obtain the target overdrive voltage, and a decreased amount can be determined according to the difference between the response times of liquid crystal corresponding to the two.

Of course, when the target refresh rate is equal to the preset refresh rate, the overdrive voltage corresponding to the gray scale value is the target overdrive voltage.

In the technical scheme provided by the present embodiment, the display panel determines an overdrive voltage of the pixel to be displayed according to the gray scale value, thereby correcting the overdrive voltage according to the target refresh rate to determine the target overdrive voltage, thus, the display panel flexibly adjusts the overdrive voltage of the pixel to be displayed according to the target refresh rate.

Referring to FIG. 6, FIG. 6 is another detailed flow diagram of operation S320 of FIG. 4, which includes:

Operation S334, determining a correction parameter according to the target refresh rate;

Operation S335, correcting the overdrive voltage according to the correction parameter to determine the target overdrive voltage of the pixel to be displayed.

In this embodiment, the display panel can determine a correction parameter according to the target refresh rate, and the correction parameter may be an incremental value, a decremental value or a correction coefficient. The correction parameter can be determined according to values of the target refresh rate and the preset refresh rate. When the target refresh rate is greater than the preset refresh rate, the correction parameter can be an incremental value or the correction coefficient be greater than 1. When the target refresh rate is less than the preset refresh rate, the correction parameter is a decrement value or the correction coefficient is less than 1. For example, the preset refresh rate is 60 Hz, and relationships between target refresh rates and gain coefficients (correction coefficients) can be shown in Table 2:

TABLE 2

| Target | Gain | Target | Gain | Target | Gain |
|---|---|---|---|---|---|
| Refresh | Coeffi- | Refresh | Coeffi- | Refresh | Coeffi- |
| Rate (Hz) | cient (%) | Rate (Hz) | cient (%) | Rate (Hz) | cient (%) |
| 45 | 92.5 | 46 | 93.0 | 47 | 93.5 |
| 48 | 94.0 | 49 | 94.5 | 50 | 95.0 |
| 51 | 95.5 | 52 | 96.0 | 53 | 96.5 |
| 54 | 97.0 | 55 | 97.5 | 56 | 98.0 |
| 57 | 98.5 | 58 | 99.0 | 59 | 99.5 |
| 60 | 100.0 | 61 | 100.5 | 62 | 101.0 |
| 63 | 101.5 | 64 | 102.0 | 65 | 102.5 |
| 66 | 103.0 | 67 | 103.5 | 68 | 104.0 |
| 69 | 104.5 | 70 | 105.0 | 71 | 105.5 |
| 72 | 106.0 | 73 | 106.5 | 74 | 107.0 |
| 75 | 107.5 | 76 | 108.0 | | |

The display panel superimposes the overdrive voltage with the incremental value or the decremental value to obtain the target overdrive voltage, or the display panel multiplies the overdrive voltage by the correction coefficient to obtain the target overdrive voltage.

In the technical scheme provided by the present embodiment, the display panel determines a correction coefficient according to the target refresh rate, thus correcting the overdrive voltage according to the correction parameter to obtain the target overdrive voltage.

Referring to FIG. 7, FIG. 7 is a detailed flow diagram of operation S200 of FIG. 2, which includes:

operation S210, determining a preset refresh rate;

operation S210, correcting the preset refresh rate according to the picture type to obtain the target refresh rate.

In this embodiment, the display panel is provided with a preset refresh rate. after determining the picture type of the current display picture, the display panel can correct the preset refresh rate according to the picture type to obtain the target refresh rate. Specifically, when the picture type is a static picture, the preset refresh rate is decreased to obtain the target refresh rate. However, when the picture type is a dynamic picture, the preset refresh rate is increased to obtain the target refresh rate. That is, the refresh rate corresponding to the dynamic picture is greater than the refresh rate corresponding to the static picture, and the principle that the refresh rate corresponding to the dynamic picture is greater than the refresh rate corresponding to the static picture has been explained above and will not be repeated here.

In the technical scheme provided by the present embodiment, the display panel determines a preset refresh rate, decreases the preset refresh rate when the picture type is a static picture, and increases the preset refresh rate when the picture type is a dynamic picture, and the display panel reasonably adjusts the refresh rate according to the picture type of the current display picture.

In one embodiment, when the current display picture is a static picture, a decreasing amount of the preset refresh rate can be determined according to the number of pixels of the current display picture that have changed, and the changed pixels here refer to pixels of the current display picture different from corresponding pixels of the previous display picture frame. Specifically, the display panel calculates a number of first pixels whose pixel values different from those of second pixels values corresponding to the first pixels. A first proportion is obtained by dividing the total number of pixels of the current display picture by the number of the first pixels whose pixel values different from those of second pixels corresponding to the first pixels. The first proportion has a mapping relationship with the decreasing amount. The display panel can determine the decreasing amount according to the first proportion. The larger the first proportion, the larger the preset refresh rate after be decreased, that is, the first proportion has a positive correlation relationship with the target refresh rate. Of course, the display panel can also determine a number of first pixels whose pixel values is same as those of second pixels corresponding to the first pixels, thus to obtain a second proportion. The second proportion has a mapping relationship with the decreasing amount, thereby decreasing the preset refresh rate according to the second proportion to obtain the target refresh rate, the larger the second proportion, the smaller the target refresh rate.

Similarly, when the current display picture is a dynamic picture, the display panel can obtain a corresponding increasing amount according to the above principle, the larger a third proportion corresponding to a number of first pixels whose pixel values being different from those of second pixels corresponding to the first pixels from the total number of the pixels of the current display picture, the larger the target refresh rate. The larger a fourth proportion corresponding to a number of first pixels whose pixel values being same to those of second pixels corresponding to the first pixels from the total number of the pixels of the current display picture, the smaller the target refresh rate.

The application also provides a display panel including a memory and at least one processor, the memory stores computer-executable instructions executable by the at least one processor, the computer-executable instructions is executed by the at least one processor to cause the at least one processor to perform the following operations:

determining a gray scale value of a pixel to be displayed of a current display picture and a picture type of the current display picture;

determining a target refresh rate according to the picture type; and

according to the target refresh rate and the gray scale value of the pixel to be displayed, determining a target overdrive voltage of the pixel to be displayed, the target refresh rate and the target overdrive voltage being positively correlated.

The application also provides a computer-readable storage medium storing computer-executable instructions executable by at least one processor, when the computer-executable instructions are executed by the at least one processor, the at least one processor is caused to perform the following operations:

determining a gray scale value of a pixel to be displayed of a current display picture and a picture type of the current display picture;

determining a target refresh rate according to the picture type; and

according to the target refresh rate and the gray scale value of the pixel to be displayed, determining a target overdrive voltage of the pixel to be displayed, the target refresh rate and the target overdrive voltage being positively correlated.

The above-mentioned serial numbers of embodiments of the present application are for illustration only and do not represent the advantages or disadvantages of the embodiments.

It should be noted that, in this document, the terms “include”, “comprise” or any other variation thereof are intended to encompass non-exclusive inclusion such that a process, method, article, or device that includes a series of elements includes not only those elements, but also other elements that are not explicitly listed, or also elements inherent to such a process, method, article, or device. Without further restrictions, an element defined by the statement “including a . . . ” does not exclude the existence of other identical elements in the process, method, article or device that includes the element.

From the above description of embodiments, it will be apparent to those skilled in the art that methods of the above embodiments can be implemented by means of software plus a necessary universal hardware platform, of course they may also be implemented by means of hardware, but in many cases the former is an optional embodiment. Based on such an understanding, the technical schemes of the application in essence or the part that contributes to the related art can be embodied in the form of software products. The computer software product is stored in a storage medium (e.g., a ROM/RAM, a disk, an optical disk) as described above and includes several instructions to cause a terminal device (which may be a mobile phone, a computer, a server, a television, a network device, etc.) to perform the methods described in various embodiments of the present application.

The above are only alternative embodiments of the application and they are not thereby limiting the scope of the patent of the application. Any equivalent structure change or equivalent flow change made by utilizing the contents of the specification and the accompanying drawings of the application, or any direct or indirect application to other related technical fields, is likewise included in the claimed scope of the application.

1. A method for determining an overdrive voltage, comprising the following operations:
determining a gray scale value of a pixel to be displayed of a current display picture and a picture type of the current display picture;
determining a target refresh rate according to the picture type; and
determining a target overdrive voltage of the pixel to be displayed according to the target refresh rate and the gray scale value of the pixel to be displayed, the target refresh rate and the target overdrive voltage being positively correlated;
wherein the operation of determining a picture type of the current display picture comprises:
acquiring a previous display picture frame;
determining a second pixel of the previous display picture frame corresponding to a first pixel of the current display picture, and comparing a pixel value of the first pixel with a pixel value of the second pixel;
determining that the current display picture is a static picture according to the picture type when a number of first pixels whose pixel values are same as pixel values of corresponding second pixels is greater than a first preset number; and
determining that the current display picture is a dynamic picture when a number of first pixels whose pixel values are different from pixel values of corresponding second pixels is greater than a second preset number.

2. The method according to claim 1, wherein the operation of determining a target overdrive voltage of the pixel to be displayed according to the target refresh rate and the gray scale value of the pixel to be displayed comprises:
determining an overdrive voltage of the pixel to be displayed according to the gray scale value; and
correcting the overdrive voltage according to the target refresh rate to obtain the target overdrive voltage of the pixel to be displayed.

3. The method according to claim 2, wherein the operation of correcting the overdrive voltage according to the target refresh rate to determine the target overdrive voltage of the pixel to be displayed comprises:
determining a correction parameter according to the target refresh rate; and
correcting the overdrive voltage according to the correction parameter to obtain the target overdrive voltage of the pixel to be displayed.

4. The method according to claim 2, wherein the operation of correcting the overdrive voltage according to the target refresh rate to determine the target overdrive voltage of the pixel to be displayed comprises:
obtaining a preset refresh rate and comparing the target refresh rate with the preset refresh rate;
in responding to that the target refresh rate is greater than the preset refresh rate, increasing the overdrive voltage to obtain the target overdrive voltage of the pixel to be displayed;
in responding to that the target refresh rate is less than the preset refresh rate, decreasing the overdrive voltage to obtain the target overdrive voltage of the pixel to be displayed.

5. The method according to claim 1, wherein the operation of determining a target refresh rate according to the picture type comprises:
determining a preset refresh rate; and
correcting the preset refresh rate according to the picture type to obtain the target refresh rate.

6. The method according to claim 5, wherein picture types comprise a static picture and a dynamic picture, and the operation of correcting the preset refresh rate according to the picture type to obtain a target refresh rate comprises:
in responding to that the current display picture is a static picture according to the picture type, decreasing the preset refresh rate to obtain the target refresh rate;
in responding to that the current display picture is a dynamic picture according to the picture type, increasing the preset refresh rate to obtain the target refresh rate.

7. The method according to claim 1, wherein after the operation of determining a target overdrive voltage of the pixel to be displayed according to the target refresh rate and the gray scale value of the pixel to be displayed, the operation further comprises:
in responding to that display of the current display picture is completed, determining a display time point of a next picture frame to be displayed according to the target refresh rate;
in responding to that the display time point arrives, taking the next picture frame to be displayed as the current display picture and returning to repeat the operation of determining a gray scale value of a pixel to be displayed of a current display picture.

8. (canceled)

9. A display panel comprising a memory and at least one processor, the memory storing computer-executable instructions executable by the at least one processor, wherein when the computer-executable instructions are executed by the at least one processor, the at least one processor is caused to perform the following operations:
determining a gray scale value of a pixel to be displayed of a current display picture and a picture type of the current display picture;
determining a target refresh rate according to the picture type; and
determining a target overdrive voltage of the pixel to be displayed according to the target refresh rate and the gray scale value of the pixel to be displayed, the target refresh rate and the target overdrive voltage being positively correlated;
wherein the operation of determining a picture type of the current display picture comprises:
acquiring a previous display picture frame;
determining a second pixel of the previous display picture frame corresponding to a first pixel of the current display picture, and comparing a pixel value of the first pixel with a pixel value of the second pixel;
determining that the current display picture is a static picture according to the picture type when a number of first pixels whose pixel values are same as pixel values of corresponding second pixels is greater than a first preset number; and
determining that the current display picture is a dynamic picture when a number of first pixels whose pixel values are different from pixel values of corresponding second pixels is greater than a second preset number.

10. The display panel according to claim 9, wherein the operation of determining a target overdrive voltage of the pixel to be displayed according to the target refresh rate and the gray scale value of the pixel to be displayed comprises:
determining an overdrive voltage of the pixel to be displayed according to the gray scale value; and
correcting the overdrive voltage according to the target refresh rate to obtain the target overdrive voltage of the pixel to be displayed.

11. The display panel according to claim 10, wherein the operation of correcting the overdrive voltage according to the target refresh rate to determine the target overdrive voltage of the pixel to be displayed comprises:
determining a correction parameter according to the target refresh rate; and
correcting the overdrive voltage according to the correction parameter to obtain the target overdrive voltage of the pixel to be displayed.

12. The display panel according to claim 10, wherein the operation of correcting the overdrive voltage according to the target refresh rate to determine the target overdrive voltage of the pixel to be displayed comprises:
obtaining a preset refresh rate and comparing the target refresh rate with the preset refresh rate;
in responding to that the target refresh rate is greater than the preset refresh rate, increasing the overdrive voltage to obtain the target overdrive voltage of the pixel to be displayed; and
in responding to that the target refresh rate is less than the preset refresh rate, decreasing the overdrive voltage to obtain the target overdrive voltage of the pixel to be displayed.

13. The display panel according to claim 9, wherein the operation of determining a target refresh rate according to the picture type comprises:
determining a preset refresh rate; and
correcting the preset refresh rate according to the picture type to obtain the target refresh rate.

14. The display panel according to claim 13, wherein picture types comprise a static picture and a dynamic picture, and the operation of correcting the preset refresh rate according to the picture type to obtain a target refresh rate comprises:
in responding to that the current display picture is a static picture according to the picture type, decreasing the preset refresh rate to obtain the target refresh rate; and
in responding to that the current display picture is a dynamic picture according to the picture type, increasing the preset refresh rate to obtain the target refresh rate.

15. A non-transitory computer-readable storage medium, wherein the non-transitory computer-readable storage medium stores computer-executable instructions executable by at least one processor, when the computer-executable instructions are executed by the at least one processor, the at least one processor is caused to perform the following operations:
determining a gray scale value of a pixel to be displayed of a current display picture and a picture type of the current display picture;
determining a target refresh rate according to the picture type; and
determining a target overdrive voltage of the pixel to be displayed according to the target refresh rate and the gray scale value of the pixel to be displayed, the target refresh rate and the target overdrive voltage being positively correlated;
wherein the operation of determining a picture type of the current display picture comprises:
acquiring a previous display picture frame;
determining a second pixel of the previous display picture frame corresponding to a first pixel of the current display picture, and comparing a pixel value of the first pixel with a pixel value of the second pixel;
determining that the current display picture is a static picture according to the picture type when a number of first pixels whose pixel values are same as pixel values of corresponding second pixels is greater than a first preset number; and
determining that the current display picture is a dynamic picture when a number of first pixels whose pixel values are different from pixel values of corresponding second pixels is greater than a second preset number.

16. The non-transitory computer-readable storage medium according to claim 15, wherein the operation of determining a target overdrive voltage of the pixel to be displayed according to the target refresh rate and the gray scale value of the pixel to be displayed comprises:
determining an overdrive voltage of the pixel to be displayed according to the gray scale value; and
correcting the overdrive voltage according to the target refresh rate to obtain the target overdrive voltage of the pixel to be displayed.

17. The non-transitory computer-readable storage medium according to claim 16, wherein the operation of correcting the overdrive voltage according to the target refresh rate to determine the target overdrive voltage of the pixel to be displayed comprises:
determining a correction parameter according to the target refresh rate; and
correcting the overdrive voltage according to the correction parameter to obtain the target overdrive voltage of the pixel to be displayed.

18. The non-transitory computer-readable storage medium according to claim 16, wherein the operation of correcting the overdrive voltage according to the target refresh rate to determine the target overdrive voltage of the pixel to be displayed comprises:
obtaining a preset refresh rate and comparing the target refresh rate with the preset refresh rate;
in responding to that the target refresh rate is greater than the preset refresh rate, increasing the overdrive voltage to obtain the target overdrive voltage of the pixel to be displayed; and
in responding to that the target refresh rate is less than the preset refresh rate, decreasing the overdrive voltage to obtain the target overdrive voltage of the pixel to be displayed.

19. The non-transitory computer-readable storage medium according to claim 15, wherein the operation of determining a target refresh rate according to the picture type comprises:
determining a preset refresh rate; and
correcting the preset refresh rate according to the picture type to obtain the target refresh rate.

20. The non-transitory computer-readable storage medium according to claim 19, wherein picture types comprise a static picture and a dynamic picture, and the operation of correcting the preset refresh rate according to the picture type to obtain a target refresh rate comprises:
in responding to that the current display picture is a static picture according to the picture type, decreasing the preset refresh rate to obtain the target refresh rate;
in responding to that the current display picture is a dynamic picture according to the picture type, increasing the preset refresh rate to obtain the target refresh rate.
